(19) United States
(12) Patent Application Publication
(10) Pub. No.: US 2020/0254403 A1
(43) Pub. Date: Aug. 13, 2020

(54) MIXER

(71) Applicant: AUTOLIV ASP, INC., Ogden, UT (US)

(72) Inventors: Richard Clarke KINMONT, JR., Roy, UT (US); Steven SCHWAB, Brigham City, UT (US)

(73) Assignee: AUTOLIV ASP, INC., Ogden, UT (US)

(21) Appl. No.: 16/271,950

(22) Filed: Feb. 11, 2019

(51) Int. Cl. B01F 7/00; B01F 3/12; B01F 7/30; B01F 15/00; B01F 15/02

(52) U.S. Cl. CPC B01F 7/00708; B01F 3/1221; B01F 2003/1257; B01F 15/00025; B01F 15/0254; B01F 7/30

(57) ABSTRACT

A mixer, particularly a dual planetary mixer, for mixing a liquid with a dry material in a mixing vessel has improved fluid introduction. The mixer includes a drive shaft rotatable about a main axis of rotation and at least a first mixing element rotatable about a first mixing element axis. The mixer further includes drive means for driving the first mixing element about the first mixing element axis in response to rotation of the drive shaft about the main axis of rotation and at least one injection nozzle for injecting a liquid. A fluid path extends between a liquid inlet and the at least one injection nozzle. The fluid path extends longitudinally through the drive shaft.

### FIELD

The present disclosure generally relates to mixers. More particularly, the present disclosure relates to a mixer with improved liquid introduction. The present disclosure also more particularly relates to a method of mixing a liquid and a dry material.

### BACKGROUND

This section provides background information related to the present disclosure which is not necessarily prior art.

Various types of mixers are known for mixing a liquid with a dry material. For example, planetary mixers are generally characterized by having one or more mixing blades that rotate about a mixing blade axis while simultaneously orbiting within a mixing vessel about a central axis. It is known to incorporate two mixing blade sets that rotate about independent mixing blade axes. Such an arrangement, commonly referred to as a dual planetary mixer, generally utilizes shorter mix times and better coverage of a mix vessel.

Planetary mixers are used to mix and otherwise process various materials. The materials processed by a planetary mixer often include a dry material and a liquid. It is generally desired to introduce the liquid into a vessel containing the dry material for mixing to create a homogenous mixture.

While known mixers, including known planetary mixers, may have proven to be generally acceptable for their intended purposes, they are all associated with disadvantages. For example, many known mixers, including but not limited to planetary mixers introduce water or other liquid into a vessel containing a dry material in an uncontrolled fashion that results in excessive amounts of material sticking to the mixing blades and/or the mixing vessel. Such sticking results in high process loss. Other mixers require discontinuous mixing and an iterative introduction of liquid, resulting in slower process times.

Accordingly, it remains desirable to advance the relevant art by overcoming the above discussed and other disadvantages associated with known planetary mixers.

### SUMMARY

This section provides a general summary of the disclosure, and is not a comprehensive disclosure of its full scope or all of its features.

It is a general object of the present teachings to provide a mixer and related method that reduce process loss.

It is also an object of the present teachings to provide a mixer, especially in the form of a dual planetary mixer, for gradual and continuous introduction of a liquid into a dry material into areas of the mixing vessel that are spaced from the mixing blades. This allows firstly to maintain the blades and the mixing vessel cleaner at the end of the mixing step. Therefore, process losses are reduced. Secondly, a uniform and controlled water distribution improves the granulation formation.

It is another object of the present teachings to provide a mixer configured to introduce a liquid into a mixing vessel by routing the liquid along a fluid path that axially extends down the length of a drive shaft of the mixer.

It is another object of the present teachings to provide a dual planetary mixer that introduces a liquid into a mixing vessel through one or more injection nozzles that are rotated along a circular path.

In accordance with one particular aspect, the present teachings provide a mixer for mixing a liquid with a dry material in a mixing vessel that has improved fluid introduction. The mixer includes a drive shaft rotatable about a main axis of rotation and at least a first mixing element rotatable about a first mixing element axis. The mixer further includes drive means for driving the first mixing element about the first mixing element axis in response to rotation of the drive shaft about the main axis of rotation and at least one injection nozzle for injecting a liquid. A fluid path extends between a liquid inlet and the at least one injection nozzle. The fluid path extends longitudinally through the drive shaft.

In accordance with another particular aspect, the present teachings provide a dual planetary mixer including a drive shaft rotatable about a main axis of rotation and first and second sets of mixing blades for rotation about first and second mixing blade axes, respectively. The dual planetary mixer additionally includes a planetary gear box arrangement coupled to the first and second sets of mixing blades for driving the first and second sets of mixing blades about the first and second axes, respectively, in response to rotation of the drive shaft about the main axis of rotation. The dual planetary mixer further includes a rail member mounted for rotation with the drive shaft. The rail member includes at least a first injection nozzle and a second injection nozzle for injecting a liquid. The first and second injection nozzles are aligned on a first imaginary line passing through the axis of rotation. The first and second injection nozzles are in fluid connection with a liquid inlet through a fluid path. The fluid path extends longitudinally through the drive shaft.

In accordance with another particular aspect, the present teachings provide a method of mixing a dry material and a liquid with a mixer. The method includes rotating first and second mixing elements about first and second mixing blade axes, respectively, and simultaneously rotating the first and second mixing blade axes about the main axis of rotation. The method additionally includes injecting the liquid into a mixing vessel containing the dry material and mixing the liquid with the dry material in the mixing vessel. Injecting the liquid includes routing the liquid through a fluid path passing longitudinally extending through a drive shaft.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a mixer in accordance with the present teaching, the mixer preferably illustrated as a planetary mixer and shown in operative association with a mixing vessel.

FIG. 2 is another perspective further illustrating a portion of the planetary mixer of the present teachings of FIG. 1.

FIG. 3 is a cross-sectional view taken along the line 3-3 of FIG. 1 further illustrating the planetary mixer of the present teachings, the planetary mixer shown schematically associated with a liquid reservoir, a control valve and a flow control device.

FIG. 4 is a bottom view of the portion of the planetary mixer shown in FIG. 2.

### DETAILED DESCRIPTION

An exemplary embodiment will now be described more fully with reference to the accompanying drawings.

An exemplary embodiment is provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that the example embodiment should not be construed to limit the scope of the present disclosure. Well-known processes, well-known device structures, and well-known technologies are not described herein in detail, for example.

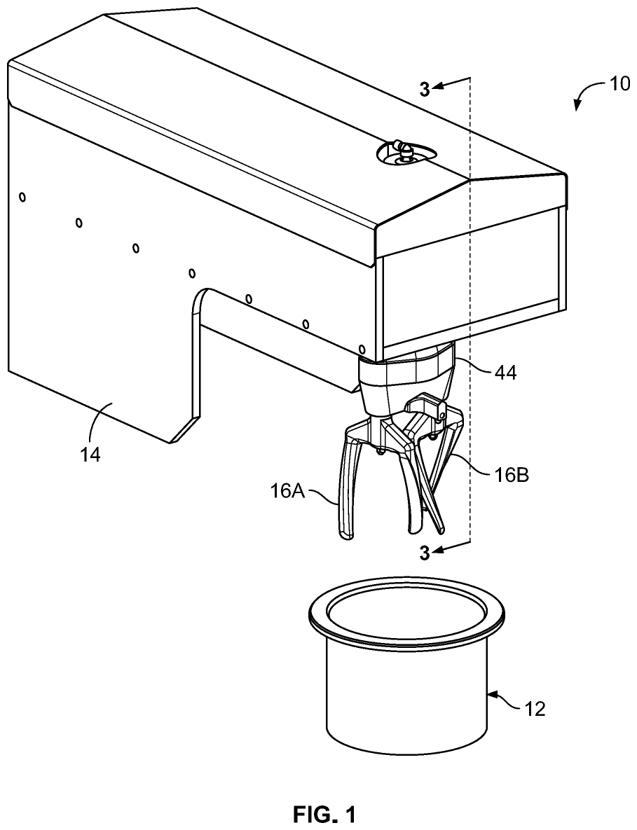

With general reference to the FIGS. 1 through 4 of drawings, a mixer constructed in accordance with the present teachings is illustrated and generally identified at reference character 10. As will become further understood from the following description, the mixer 10 of the present teachings is preferably a dual planetary mixer with mixing blade sets that revolve around a main axis while simultaneously rotating about individual mixing blade axes. The dual planetary mixer 10 is shown in FIG. 1 operatively associated with a mixing vessel 12.

The dual planetary mixer 10 of the present teachings is illustrated to generally include a mixer housing 14, at least one mixing element including a first mixing element 16A, and a drive arrangement 18 for driving the at least one mixing element 16. In the embodiment illustrated, the at least one mixing element preferably includes first and second mixing elements 16A and 16B.

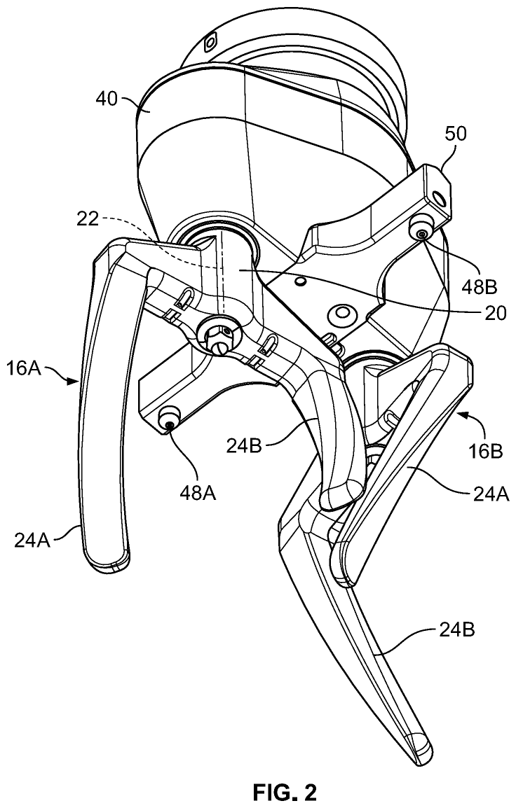

Each mixing element 16A and 16B may include an upper central mounting collar 20 defining a vertically extending bore 22 (see FIG. 2, for example). Each mixing element 16A and 16B may further include a set of mixing blades having at least one mixing blade and preferably including first and second mixing blades 24A and 24B. The particular configuration of the mixing blades 24A and 24B will be understood to be conventional and beyond the scope of the present teachings. Explaining further, any mixing blade configuration well known in the art or developed hereafter may be used within the scope of the present teachings.

The dual planetary mixer 10 further includes a drive arrangement 26 driving a drive shaft 28, and in turn driving the first and second mixing elements 16A and 16B. The first mixing element 16A is rotatable about a first mixing element axis 30A and the second mixing element 16B is rotatable about a second mixing element axis 30B. The drive shaft 28 rotates about a longitudinally extending axis or main axis of rotation 32. The drive arrangement 26 includes a gear motor 34 mounted on a frame 36 within the housing 14.

The drive arrangement 26 further includes drive means for driving the first and second mixing elements 16A and 16B about the first and second mixing element axes 30A and 30B, respectively, in response to rotation of the drive shaft 28 about the main axis of rotation 32. The drive means includes a planetary gear arrangement 38 having a housing 40 and a planetary gear set 42. A first member 44 of the planetary gear arrangement 38 is non-rotatably mounted to the frame 36. The housing 40, or second member, rotates relative to the first member 44 about the axis 32. The drive shaft 28 extends through the first and second members 44 and 38. Suitable seals 46 are provided between the first member 44 and the drive shaft 28 such that the drive shaft 28 may rotate relative to the first member 44. In the embodiment illustrated, the first and second mixing element axes 30A and 30B are radially spaced from the main axis of rotation 32 of the drive shaft 28.

The mixer 10 includes at least one injection nozzle for the introduction of a fluid into the mixing vessel 12. In the embodiment illustrated, the at least one injection nozzle includes first and second injection nozzles 48A and 48B radially spaced from the main axis of rotation 32 of the drive shaft 28 on opposite sides of the main axis of rotation 32. Each injection nozzles 48A and 48B is configured to generate a linearly directed liquid jet for injecting the liquid into a corresponding area of the mixing vessel 12. It will be understood that the mixer 10 may include a greater or lesser number of injection nozzles within the scope of the present teachings.

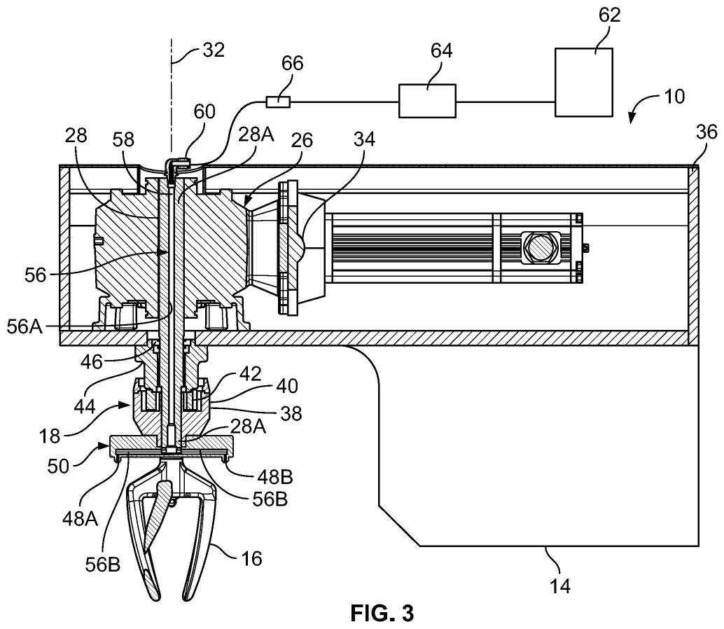

In the embodiment illustrated, the injection nozzles 48A and 48B are carried on a rail member 50. The rail member 50 is mounted for rotation with the drive shaft 28. As particularly shown in the cross-sectional view of FIG. 3, the rail member 50 is carried by the drive shaft 28 proximate a distal end 28A of the drive shaft 28. The rail member 50 is elongated along a longitudinal axis.

The first and second injection nozzles 48A and 48B may be disposed on a first imaginary line 52. The first imaginary line 52 may define the longitudinal axis of the rail member 50. The first imaginary line 52 may be perpendicular to a second imaginary line 54 passing through the first and second mixing element axis 30A and 30B. The second imaginary line 54 also passes through the axis of rotation 32 of the drive shaft 28.

The mixer 10 defines a fluid path 56 extending between a liquid inlet 58 and the at least one injection nozzle 48A and 48B. The fluid path 56 includes a first portion or axially extending portion 56A axially extending through the drive shaft 28 from a proximal end 28B of the drive shaft 28 to the distal end 28A of the drive shaft 28. The fluid path 56 further includes at least one second portion or radially extending portion 56B. The at least one second portion 56B may include first and second portions defined by the rail member 50. The second portions 56B of the fluid path 56 radially extend from the first portion 56A to the injection nozzles 48A and 48B.

A rotary union 60 is provided at the proximal end 28A of the drive shaft 28. The rotary union 60 is in fluid communication with a water reservoir 62. A flow control 64 and a control valve 66 are provided between the water reservoir 62 and the rotary union to control the flow of liquid from the fluid reservoir 62 to the fluid path 56 in a manner well known in the art.

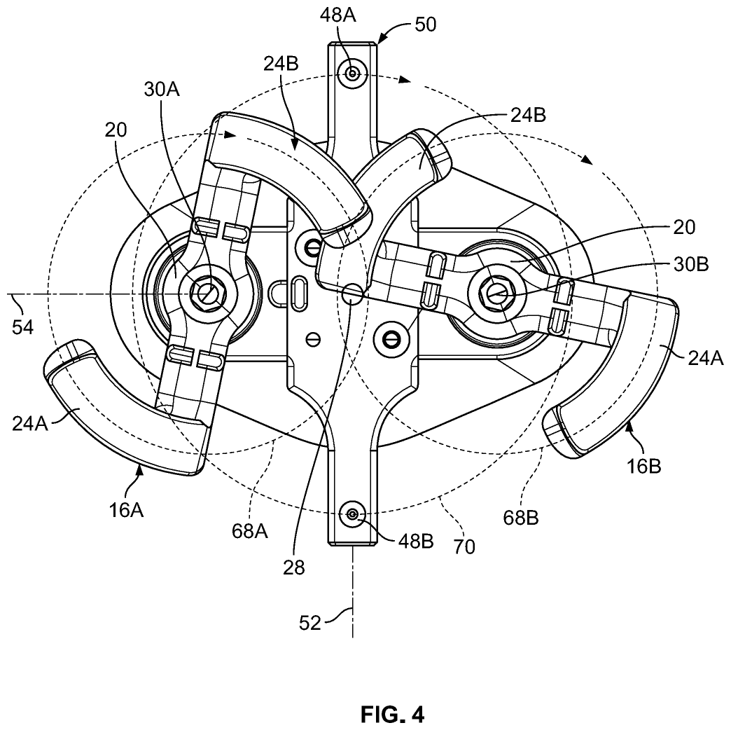

The mixing blades 24A and 24B of the first mixing element 16A follow a first mixing blade path 68A when the first mixing element 16A is rotated about the first mixing element axis 30A. Similarly, the mixing blades 24A and 24B of the second mixing element 16B follow a second mixing blade path 68B when the second mixing element 16B is rotated about the second mixing element axis 30B. The first and second mixing blade paths 68A and 68B are circular paths that orbit about the axis of rotation 32 of the drive shaft 28. In the embodiment illustrated, the first and second mixing blade paths 68A and 68B overlap at the drive shaft 28. As shown in FIG. 4, the blades 24A and 24B of the first and second mixing element 16A and 16B are rotated in a clockwise direction along the first and second mixing blade paths 68A and 68B, respectively.

The first and second injection nozzles 48A and 48B may be equally spaced from the axis of rotation 32 of the drive shaft 28 in the radial direction. As such, when the drive shaft 28 is rotated, the first and second injection nozzles 48A and 48B may follow a circular injection nozzle path 70. As shown in FIG. 4, the injection nozzles 48A and 48B are rotated in a clockwise direction along the circular injection nozzle path 70.

The first injection nozzle 48A is positioned to inject liquid into a first area that is spaced from both the first mixing blade path 68A and the second mixing blade path 68B. Similarly, the second injection nozzle 48B is positioned to inject liquid into a second area that is also spaced from both the first mixing blade path 68A and the second mixing blade path 68B. Explaining further, the mixer 10 is configured such that the liquid injected from the first and second injection nozzles 48A and 48B is directed away from the mixing blades 24A and 24B and may impact the dry material in the mixing vessel 12 before encountering the mixing blades 24A and 24B allowing maintaining the blades and the mixing vessel cleaner at the end of the mixing step. As a consequence, process losses are reduced. A uniform and controlled water distribution improves the granulation formation.

In one particular example, the mixer 10 of the present teachings may be used to prepare an igniting material for a pyrotechnic device. Such pyrotechnic devices are common in motor vehicles, for example, to deploy airbags. By way of example and without limitation, the igniting material may include a may include a liquid in the form of water.

The dry material or the material to be mixed and hydrated is placed in the mixing vessel 12 in a dry state. The liquid may be injected into the mixing vessel 12 in a gradual and continuous manner while the first and second mixing elements 16A and 16B are simultaneously rotated about the first and second mixing blade axes 30A and 30B, respectively. Introduction of the liquid into the mixing vessel 12 through linearly directed liquid jets in the areas spaced from both the first mixing blade path 68A and the second mixing blade path 68B results in reduced build up on the blades 24A and 24B of the first and second mixing elements 16A and 16B and on the mixing vessel 12.

In one particular application, the maximum speed for rotating the first and second mixing elements 16A and 16B about the first and second mixing element axes 30A and 30B is approximately 200 rpm and preferably no greater than 150 rpm.

While the first and second mixing element axes 30A and 30B are spaced from the main axis of rotation 32 of the drive shaft 28 in the embodiment illustrated, it will be understood, that the first mixing element axis 30A may alternatively be concentric with the main axis of rotation 32. For example, the mixer 10 may be constructed to include a single mixing element rotatable about an axis concentric with the longitudinal axis or axis of rotation of a drive shaft. In such an arrangement, which will be understood to be within the scope of the present teachings, an alternative drive means may be used to drive the single mixing element. In this regard, the first mixing element 16A may be driven directly by the drive shaft 28 rather than through a planetary gear arrangement. The present teachings may also be incorporated into a mixer 10 having a single blade that is non-concentric with the main axis of rotation 32.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mixer for mixing a liquid with a dry material in a mixing vessel, the mixer comprising:
a drive shaft rotatable about a main axis of rotation;
at least a first mixing element rotatable about a first mixing element axis;
drive means for driving the first mixing element about the first mixing element axis, in response to rotation of the drive shaft about the main axis of rotation;
at least one injection nozzle for injecting a liquid; and
a fluid path extending between a liquid inlet and the at least one injection nozzle, the fluid path passing longitudinally through the drive shaft.

2. The mixer according to claim 1, further comprising a second mixing element rotatable about a second mixing element axis.

3. The mixer according to claim 2, wherein the drive means includes a planetary gear arrangement and the first and second mixing element axes rotate about the main axis of rotation.

4. The mixer according to claim 1, wherein the at least one injection nozzle is radially spaced from the drive shaft.

5. The mixer according to claim 1, wherein the at least one injection nozzle includes first and second injection nozzles radially spaced from one another on a first imaginary line passing through the main axis of rotation, the first and second injection nozzles being on opposite radial sides of the main axis of rotation.

6. The mixer according to claim 5, wherein a second imaginary line passes through the first and second mixing element axes and the main axis of rotation, the second imaginary line being generally perpendicular to the first imaginary line.

7. The mixer according to claim 1, wherein the first mixing element includes a first set of mixing blades that follow a first mixing blade path when the first mixing element is rotated about the first mixing element axis.

8. The mixer according to claim 7, wherein the at least one nozzle is configured to generate at least one directed liquid jet for injecting the liquid into at least one area spaced from the first mixing blade path.

9. The mixer according to claim 2, wherein the first mixing element includes a first set of mixing blades that follow a first mixing blade path when the first mixing element is rotated about the first mixing element axis and the second mixing element includes a second set of mixing blades that follow a second mixing blade path when the second mixing element is rotated about the second mixing element axis.

10. The mixer according to claim 9, wherein the at least one injection nozzle is configured to generate at least one directed liquid jet for injecting the liquid into at least one area spaced from both of the first and second mixing blade paths.

11. The mixer according to claim 1, wherein the at least one injection nozzle is radially spaced from the main axis of rotation and is rotatable about the main axis of rotation.

12. The mixer according to claim 1, wherein the at least one injection nozzle includes first and second injection nozzles on radially opposite sides of the main axis of rotation.

13. The mixer according to claim 1, further comprising a rail member mounted for rotation with the drive shaft, the fluid path for the liquid radially passing through the rail member from the drive shaft to the at least one injection nozzle.

14. The mixer according to claim 1, wherein the at least one injection nozzle includes first and second injection nozzles and the fluid path extends in first and second radially opposite directions from the drive shaft to the first and second injection nozzles, respectively.

15. The mixer according to claim 3, wherein the mixer is a dual planetary mixer.

16. A dual planetary mixer comprising:
a drive shaft rotatable about a main axis of rotation;
first and second sets of mixing blades for rotation about first and second mixing blade axes, respectively;
a planetary gear box arrangement coupled to the first and second sets of mixing blades for driving the first and second sets of mixing blades about the first and second axes, respectively, in response to rotation of the drive shaft about the main axis of rotation; and
a rail member mounted for rotation with the drive shaft, the rail member including at least a first injection nozzle and a second injection nozzle for injecting a liquid, the first and second injection nozzles aligned on a first imaginary line passing through the axis of rotation, the first and second injection nozzles in fluid connection with a liquid inlet through a fluid path, the fluid path extending longitudinally through the drive shaft.

17. The dual planetary mixer of claim 16, wherein a second imaginary line passes through the first and second mixing blade axes and the main axis of rotation, the second imaginary line being perpendicular to the first imaginary line.

18. A method of mixing a dry material and a liquid with the mixer according to claim 1, the method comprising:
rotating the first mixing element about the first mixing element axis;
injecting the liquid into a mixing vessel containing the dry material; and
mixing the liquid with the dry material in the mixing vessel,
wherein injecting the liquid includes routing the liquid through the fluid path passing longitudinally through the drive shaft.

19. The method according to claim 18, wherein the mixer further includes a second mixing element rotatable about a second mixing element axis and the method further comprises simultaneously rotating the first and second mixing blade elements about the main axis of rotation while injecting the liquid into the mixing vessel, and rotating the first and second mixing elements about the first and second mixing element axes, respectively.

20. The method according to claim 19, wherein the first mixing element includes a first set of mixing blades that follow a first mixing blade path when the first mixing element is rotated about the first mixing element axis and the second mixing element includes a second set of mixing blades that follow a second mixing blade path when the second mixing element is rotated about the second mixing element axis, and the method further comprises injecting the liquid into at least one area spaced from the first and second mixing blade paths.
